(19) United States
(12) Patent Application Publication
(10) Pub. No.: US 2020/0301624 A1
(43) Pub. Date: Sep. 24, 2020

(54) INFORMATION PROCESSING DEVICE, IMAGE FORMING APPARATUS, AND NON-TRANSITORY COMPUTER READABLE MEDIUM

(71) Applicant: FUJI XEROX CO., LTD., Tokyo (JP)

(72) Inventor: Hideharu IWASHITA, Kanagawa (JP)

(73) Assignee: FUJI XEROX CO., LTD., Tokyo (JP)

(21) Appl. No.: 16/551,455

(22) Filed: Aug. 26, 2019

(30) Foreign Application Priority Data
Mar. 20, 2019 (JP) 2019-052473

(51) Int. Cl. G06F 3/12

(52) U.S. Cl. CPC G06F 3/1208; G06F 3/1256

(57) ABSTRACT

An information processing device includes a specifying unit, an acquiring unit, and a display. The image forming apparatus includes one or more mounted portions to which containers filled with different types of color materials are mountable. The specifying unit is configured to specify color material information indicating a color material filled in a container actually mounted to the one or more mounted portions in the image forming apparatus. The acquiring unit is configured to acquire first image data indicating a first image. The display is configured to display a second image using the color material information and the first image data.

### CROSS-REFERENCE TO RELATED APPLICATIONS

This application is based on and claims priority under 35 USC 119 from Japanese Patent Application No. 2019-052473 filed Mar. 20, 2019.

### BACKGROUND

### (i) Technical Field

The present disclosure relates to an information processing device, an image forming apparatus, and a non-transitory computer readable medium.

### (ii) Related Art

An image forming apparatus is known that generates a preview image based on print data and displays the preview image on a user interface screen (UI). Also, an image forming apparatus has been proposed that has plural mounted portions to which containers filled with color materials such as toner or ink used in transferring images onto a medium (for example, a print sheet) and superimposes plates of the respective color materials to form an image (see, for example, JP-A-5-301382).

### SUMMARY

In an image forming apparatus including plural mounted portions to which containers filled with different color materials are mountable, what colors of color materials are actually mounted to the image forming apparatus are not reflected in a preview image, and an actual printed matter may be different from the preview image.

Aspects of non-limiting embodiments of the present disclosure relate to confirming an image to be formed by an image forming apparatus using acquired image data, based on color material information indicating a color material filled in a container actually mounted to the image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including: a specifying unit, in which an image forming apparatus includes one or more mounted portions to which containers filled with different types of color materials are mountable, the specifying unit configured to specify color material information indicating a color material filled in a container actually mounted to the one or more mounted portions in the image forming apparatus; an acquiring unit configured to acquire first image data indicating a first image; and a display configured to display a second image using the color material information and the first image data.

### BRIEF DESCRIPTION OF THE DRAWINGS

Exemplary embodiment(s) of the present disclosure will be described in detail based on the following figures, wherein:

FIG. 1 is a block diagram illustrating an example of the configuration of an image forming apparatus 1 according to an exemplary embodiment of the present disclosure;

FIG. 2 is a functional block diagram illustrating the functional configuration of an information processing device 30 in the image forming apparatus 1;

FIG. 3 is a flowchart illustrating a preview displaying process according to the exemplary embodiment;

FIG. 4 is a view illustrating an example of an image to be printed;

FIG. 5 is a view illustrating an example of a preview image displayed on a display 50;

FIG. 6 is a view illustrating an example of a message displayed on the display 50; and

FIG. 7 is a flowchart illustrating a modification of the preview displaying process.

### DETAILED DESCRIPTION

Hereinafter, an exemplary embodiment of the present disclosure will be described with reference to the accompanying drawings.

### Exemplary Embodiment

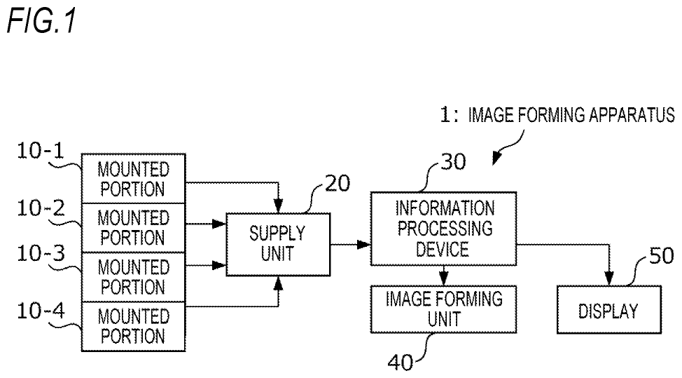

FIG. 1 is a block diagram illustrating an example of the configuration of an image forming apparatus 1 according to the exemplary embodiment of the present disclosure. The image forming apparatus 1 according to the present exemplary embodiment is, for example, a laser printer in which five or more color toners including a spot color are replaceable and which has a preview function. As illustrated in FIG. 1, the image forming apparatus 1 includes mounted portions 10-1 to 10-4, a supply unit 20, an information processing device 30, an image forming unit 40, and a display 50. In addition to the components illustrated in FIG. 1, the image forming apparatus 1 may include an image reader such as a scanner, and a communication device that communicates with another device via a communication network such as a LAN (Local Area Network) or a telephone line.

A container (for example, a toner cartridge in the present exemplary embodiment) filled with a color material (for example, a toner in the exemplary embodiment) is mountable to each of the mounted portions 10-1 to 10-4. Containers filled with color materials of different colors from each other are mounted to the mounted portions 10-1 to 10-4, respectively. Hereinafter, when there is no need to distinguish the mounted portions 10-1 to 10-4 from each other, the mounted portions 10-1 to 10-4 may be collectively referred to as “mounted portions 10”. In the present exemplary embodiment, the image forming apparatus 1 including the four mounted portions 10 will be described. Alternatively, the number of mounted portions 10 may be one or more, three or less, or five or more. In short, the image forming apparatus 1 may have one or more mounted portions 10.

In an image forming apparatus of the related art to which plural color materials are mountable, colors of the color materials to be filled in containers mounted to the mounted portions are determined in advance for the respective mounted portions. In this regard, in the image forming apparatus 1, the colors of the color materials to be filled in the containers mounted to the respective mounted portions 10-1 to 10-4 are not determined in advance. The image forming apparatus 1 is different in this point from the image forming apparatus of the related art. In the present exemplary embodiment, a color material of one of C (cyan), M (magenta), Y (yellow), K (black) and a spot color is filled in a container mountable to the mounted portion 10. The term “spot color” refers to a color that may not be expressed by a subtractive mixture of C, M and Y, such as gold, silver, white and a luminescent color. Further, a semiconductor chip is built in the container mountable to the mounted portion 10. The semiconductor chip stores a color ID that is an identifier indicating the color of a color material filled in the container. Although not illustrated in detail in FIG. 1, the mounted portion 10 includes electrodes electrically connected with the semiconductor chip built in the container. In the present exemplary embodiment, the color ID is read out via the electrodes.

In the image forming apparatus 1, the transfer order in which the color materials filled in the containers mounted to the mounted portions 10 are transferred is determined in advance for the respective mounted portions 10. Specifically, the color materials are transferred onto a medium such as a printing sheet in such a manner that the color material filled in the container mounted to the mounted portion 10-1 is placed in the lowermost, the color material filled in the container mounted to the mounted portion 10-2 is placed thereon, the color material filled in the container mounted to the mounted portion 10-3 is further placed thereon, and the color material filled in the container mounted to the mounted portion 10-4 is placed in the uppermost. Therefore, the color of the color material filled in the container mounted to the mounted portion 10-1 may be the darkest, the color of the color material filled in the container mounted to the mounted portion 10-2 may be the second darkest, the color of the color material filled in the container mounted to the mounted portion 10-3 may be the third darkest, and the color of the color material filled in the container mounted to the mounted portion 10-4 may be the lightest. The reason for this is to prevent a lighter color from being painted by a darker color. For example, when four containers filled with color materials of C, M, Y, and K are mounted to the mounted portions 10-1 to 10-4, respectively, the container filled with the K color material may be mounted to the mounted portion 10-1, the container filled with the C color material may be mounted to the mounted portion 10-2, the container filled with the M color material may be mounted to the mounted portion 10-3, and the container filled with the Y color material may be mounted to the mounted portion 10-4.

The supply unit 20 is an interface circuit that reads out the color ID from the semiconductor chip incorporated in the container actually mounted to the mounted portion 10 via the electrodes and supplies the color ID to the information processing device 30.

The information processing device 30 is a computer that controls the image forming apparatus 1. The information processing device 30 acquires first image data representing an image to be printed by the image forming apparatus 1 (hereinafter, referred to as a “first image”), and performs a process for displaying preview of the image. The details of the process executed by the information processing device 30 will be described later.

The image forming unit 40 includes, for example, a photoconductor. The image forming unit 40 forms the first image on a medium such as a print sheet using the color material information and the first image data under the control of the information processing device 30. The display 50 is, for example, a liquid crystal display. The display 50 displays various images under the control of the information processing device 30. The image forming unit 40 and the display 50 are not particularly different from those in the image forming apparatus of the related art. Therefore, the detailed explanation thereof will be omitted.

The information processing device 30 includes, for example, a controller such as a central processing unit (CPU), a random access memory (RAM), and a storage unit such as a hard disk drive, although not illustrated in detail in FIG. 1.

The storage unit stores various programs such as an in-printer application program, system parameters, and a color material mounting order list in advance. An example of the in-printer application program is a preview display program that causes the information processing device 30 to implement a preview display that remarkably represents features of the present disclosure.

The system parameters include setting information related to a function of the image forming apparatus 1 such as information indicating the availability of preview display, and color material information. The color material information is information indicating a color material filled in the container actually mounted to each of the one or more mounted portions. More specifically, the color material information is data that associates an identifier of each of the mounted portions 10-1 to 10-4 with a color ID of the color material filled in the container actually mounted to each of the mounted portions 10-1 to 10-4. In the present exemplary embodiment, the transfer order in which the color materials mounted to the mounted portions 10 are transferred is determined in advance for the respective mounted portions 10. Therefore, the color material information is data indicating a combination of color materials actually mounted to the image forming apparatus 1 and indicating the transfer order in which the respective colors are transferred.

The color material mounting order list is data indicating colors of color materials to be filled in the containers mounted to the mounted portions 10-1 to 10-4 for each combination of colors of color materials filled in containers mounted to the mounted portions 10-1 to 10-4. In other words, the color material mounting order list is data indicating a correct transfer order in which the color materials of the respective colors are transferred, for each color combination. The transfer order for each color combination in which the color materials of the colors are transferred may be referred to as a “color material mounting order” (in which the color materials are mounted). In the following, for example, for a combination of C, M, Y and K, the color material mounting order list indicates that the container of the K color material is to be mounted to the mounted portion 10-1, the container of the C color material is to be mounted to the mounted portion 10-2, the container of the M color material is to be mounted to the mounted portion 10-3, and the container of the Y color material is to be mounted to the mounted portion 10-4. For a combination of gold, K, M and Y, the color material mounting order list indicates that the container of the gold color material is to be mounted to the mounted portion 10-1, the container of the K color material is to be mounted to the mounted portion 10-2, the container of the M color material is to be mounted to the mounted portion 10-3, and the container of the Y color material is to be mounted to the mounted portion 10-4.

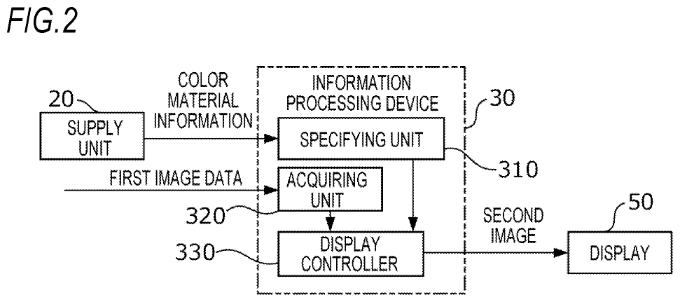

The RAM is used as a work area during execution of a program. When the image forming apparatus 1 is supplied with power from a power source (not illustrated in FIG. 1), the controller reads the preview display program from the storage unit into the RAM and starts execution of the program. The information processing device 30 functions as a specifying unit 310, an acquiring unit 320, and a display controller 330 illustrated in FIG. 2 by causing the controller to operate according to the preview display program. The roles of the specifying unit 310, the acquiring unit 320 and the display controller 330 illustrated in FIG. 2 are as follows.

The specifying unit 310 acquires, from the image forming apparatus 1, a color ID indicating the color material filled in the container actually mounted to one or more mounted portions 10 and specifies the color material information. The specifying unit 310 of the present exemplary embodiment specifies the color material information using the color ID given from the supply unit 20. Meanwhile, the color ID of the container actually mounted to the one or more mounted portions 10 may be stored in advance in a management apparatus or cache separate from the image forming apparatus 1, and may be acquired by the specifying unit 310 via the management apparatus or cache. The specifying unit 310 writes the specified color material information in the storage unit, as one of the system parameters.

The acquiring unit 320 acquires the first image data. Examples of how to acquire the first image data include (i) acquiring the first image data via an image reader, (ii) acquiring the first image data by downloading the first image data via a communication device, (iii) acquiring the first image data by receiving the first image data via facsimile, and the like.

The display controller 330 executes a preview displaying process. The preview displaying process is a process of causing the display 50 to display a preview image (hereinafter, which may be referred to as a “second image”) of the first image using the color material information included in the system parameter and the first image data. The second image is scaled to be suitable for display on the display 50. The second image is different from the first image at least in this point.

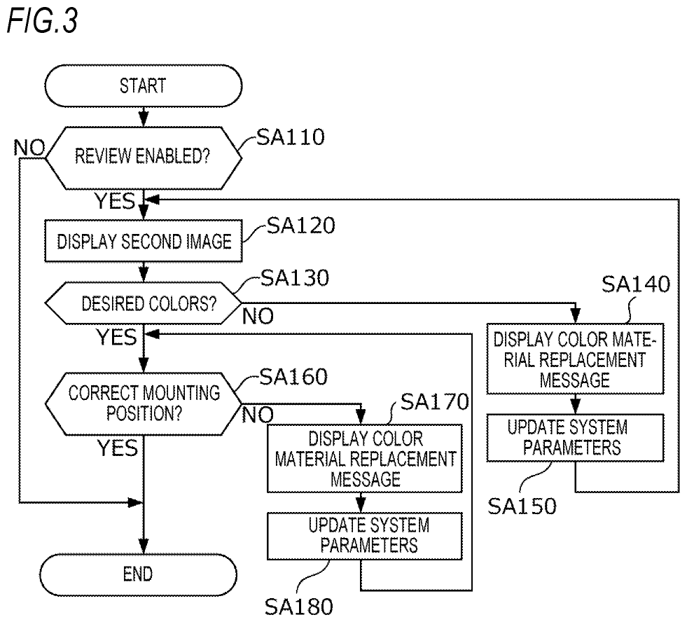

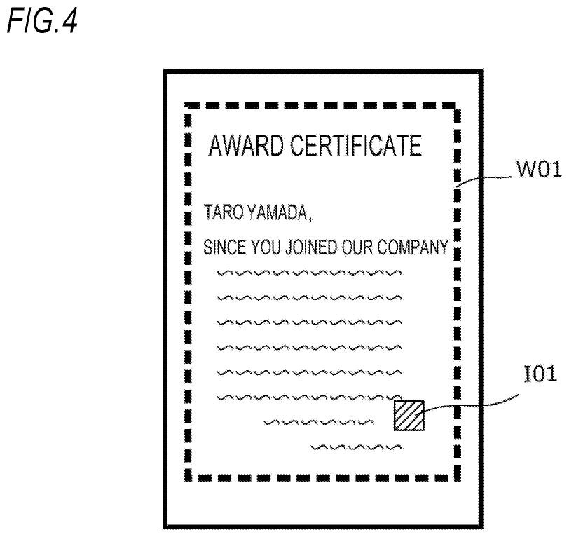

FIG. 3 is a flowchart illustrating the preview displaying process performed by the display controller 330. Hereinafter, the operation of the display controller 330 will be described by taking an example in which the container of the K color material is mounted to the mounted portion 10-1, the container of the C color material is mounted to the mounted portion 10-2, the container of the M color material is mounted to the mounted portion 10-3, and the container of the Y color material is mounted to the mounted portion 10-4. At the start of the operation described below, the storage unit stores the system parameters which include the color material information indicating the colors (that is, K, C, M and Y) of the color materials actually mounted to the mounted portions 10-1 to 10-4, and which indicate that the preview display is enabled. In the following, it is assumed that the first image data representing the first image illustrated in FIG. 4 is acquired by the acquiring unit 320. As illustrated in FIG. 4, the first image of this operation example is an image of an award certificate. The first image data includes data that designates K as a color of characters such as an “award certificate”, M as a color of a seal I01 representing an imprint of an issuer of the award certificate, and gold as a color of a frame W01.

In the preview displaying process illustrated in FIG. 3, the display controller 330 first refers to the system parameters to determine whether the preview display is enabled (step SA110). When the determination result in step SA110 is “No”, the display controller 330 ends the preview displaying process. Thereafter, the information processing device 30 waits for an instruction to start printing from a user, and causes the image forming unit 40 to print the first image upon receiving the instruction to start printing. As described above, in the present operation example, the storage unit stores the system parameters indicating that the preview display is enabled. Therefore, the determination result in step SA110 is “Yes”.

When the determination result in step SA110 is “Yes”, the display controller 330 generates the second image from the first image data, causes the display 50 to display the second image, and inquires the user whether desired colors are obtained (step SA120). More specifically, in step SA120, the display controller 330 first generates, based on the first image data, intermediate data representing plates of the respective colors indicated by the color material information included in the system parameters. Next, the display controller 330 performs an RGB conversion on the intermediate data to generate the second image data (for example, data in the JPEG format) representing the second image, and causes the display 50 to display the second image according to the second image data. When the first image data includes data designating a color that may be not be expressed by the respective colors indicated by the color material information stored in the storage unit during generation of the intermediate data, the display controller 330 generates the intermediate data except for data for which the color is designated. As described above, the color material information of the present exemplary embodiment indicates not only a combination of color materials actually mounted to the image forming apparatus 1 but also the transfer order in which the color materials are transferred. Therefore, when the second image is displayed, only the combination of colors indicated by the color material information may be reflected in the second image, or the transfer order in which the color materials are transferred may be reflected in the second image in addition to the combination of colors.

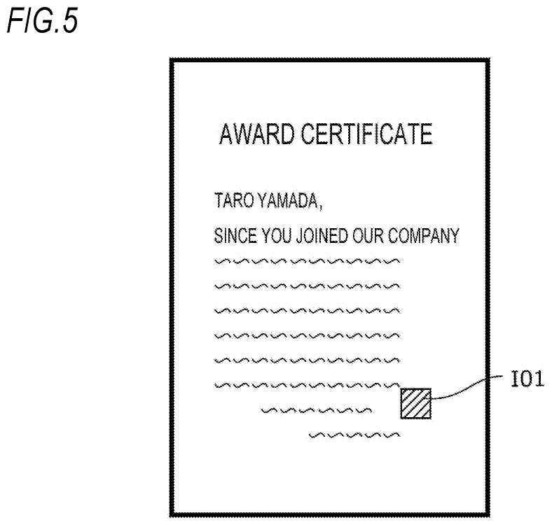

As described above, at the start of this operation example, the first image data includes data designating a spot color (for example, gold in this operation example) that may not be represented by the respective colors (for example, K, C, M, and Y in this operation example) indicated by the color material information at that point of start. Therefore, the display controller 330 generates the intermediate data except for data for which printing in a spot color is designated, and causes the display 50 to display the second image. As a result, in this operation example, as illustrated in FIG. 5, an image of the award certificate from which the frame W01 is removed is displayed on the display 50 as the second image.

The user who visually recognizes the second image displayed on the display 50 determines whether his/her desired colors are achieved, and inputs the determination result to an operation unit (not illustrated in FIG. 1) of the image forming apparatus 1. Meanwhile, the display controller 330 determines whether the user's desired colors are achieved, in response to the operation performed on the operation unit (step SA130). When the determination result in step SA130 is “No”, the display controller 330 executes processes of step SA140 and step SA150. Meanwhile, when the determination result in step SA130 is “Yes”, the display controller 330 executes processes in step SA160 and subsequent steps.

As described above, in this operation example, the image illustrated in FIG. 5 is displayed on the display 50 as a preview image of the first image illustrated in FIG. 4. The user who visually recognizes the image illustrated in FIG. 5 understands that the gold frame portion W01 will not be printed, determines that his/her desired colors are not achieved, and inputs the determination result to the operation unit. Therefore, the determination result in step SA130 is “No”, and the processes of step SA140 and step SA150 are performed.

In step SA140, the display controller 330 causes the display 50 to display a message that prompts the user to replace a color material(s). The user who visually recognizes this message replaces the color material(s). In the following, the subsequent operation will be described by taking as an example a case where the container filled with the C color material is replaced with a container filled with the gold color material, that is, a case where a container filled with a spot color (for example, gold in this operation example) material is mounted to the mounted portion 10-2 in place of the container filled with the C color material.

When the user replaces the color material, the color material information on the newly mounted color material is specified by the specifying unit 310, and the system parameters are updated (step SA150). In this operation example, in place of the container filled with the C color material, the container filled with the spot color (for example, gold in this operation example) material is mounted to the mounted portion 10-2. Therefore, the color material information included in the system parameter is updated to information indicating K, gold, M, and Y. Thereafter, the display controller 330 executes the processes of step SA120 and subsequent steps again.

After the replacement of the color material(s), at the point of time when step SA120 is executed, the color material information included in the system parameters has been updated to information indicating the respective colors of the spot color (for example, gold in this operation example), M, Y and K. Therefore, as in the image illustrated in FIG. 4, the second image including the frame portion W01 is displayed on the display 50. Further, since data designating C is not included in the first image data in this operation example, the second image without any missing data is displayed on the display 50 as compared with the image illustrated in FIG. 4. During the generation of the intermediate data in step SA120, intermediate data for each of colors of K, C, M and Y and intermediate data of the spot color may be generated separately or collectively. In addition, when a container of the spot color is mounted in place of the container of K, black may be expressed by process black in the intermediate data. The “process black” refers to black expressed by a mixture of C, M and Y. In addition, when the spot color indicated by the color material information is a color that may not be expressed by any mixed color of R, G and B, the spot color may be changed to a similar color which may be expressed by a mixed color of R, G and B during the RGB conversion, for display of the second image. For example, when the spot color is gold, the spot color may be changed to an ocher color for display of the second image.

As described above, the user who visually recognizes the second image including the frame W01 determines that his/her desired colors are achieved, and inputs the determination result to the operation unit. Therefore, the determination result in step SA130 which is executed again in this operation example is “Yes”, and the processes of step SA160 and subsequent steps are executed.

In step SA160, the display controller 330 refers to the color material mounting order list and the color material information included in the system parameters to determine whether the color material mounting order is correct. When the determination result in step SA160 is “Yes”, the display controller 330 ends the preview displaying process. Thereafter, the information processing device 30 waits for an instruction to start printing from a user, and causes the image forming unit 40 to print the first image upon receiving the instruction to start printing. Meanwhile, when the determination result in step SA160 is “No”, the display controller 330 executes processes of step SA170 and subsequent steps.

The color material information at the point of time when the process of step SA160 is executed indicates that the color of the color material of the container mounted to the mounted portion 10-1 is K, the color of the color material of the container mounted to the mounted portion 10-2 is the spot color (for example, gold in this operation example), the color of the color material of the container mounted to the mounted portion 10-3 is M, and the color of the color material of the container mounted to the mounted portion 10-4 is Y. For a combination of gold, K, M and Y, the color material mounting order list indicates that the container of the gold color material is to be mounted to the mounted portion 10-1, the container of the K color material is to be mounted to the mounted portion 10-2, the container of the M color material is to be mounted to the mounted portion 10-3, and the container of the Y color material is to be mounted to the mounted portion 10-4. Since the mounting order indicated by the color material information included in the system parameters does not match the mounting order indicated by the color material mounting order list as described above, the determination result in step SA160 is “No”. Therefore, in this operation example, the processes of step SA170 and subsequent steps are performed.

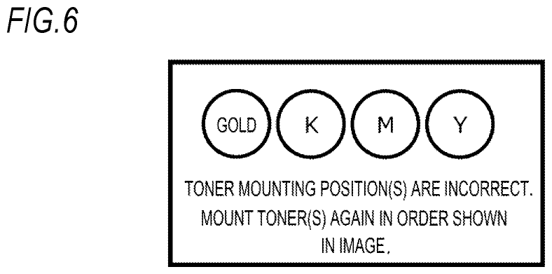

In step SA170, the display controller 330 causes the display 50 to display a message that notifies the user of a correct mounting order (see FIG. 6) to prompt the user to replace the color material(s). The user who visually recognizes the message replace the color material(s) so that the color materials are mounted in the mounting order suggested by the message. When the user replaces the color material(s), the color material information on the newly mounted color material is specified by the specifying unit 310, the system parameters are updated (step SA180), and the display controller 330 ends the preview displaying process. Thereafter, the information processing device 30 waits for an instruction to start printing from a user, and causes the image forming unit 40 to print the first image upon receiving the instruction to start printing.

As described above, the image forming apparatus 1 of the present exemplary embodiment includes the one or more mounted portions 10 to which he containers filled with different types of color materials are mountable. The image forming apparatus 1 of the exemplary embodiment further includes the specifying unit 310 that specifies the color material information indicating the color materials filled in the containers actually mounted to the one or more mounted portions 10, the acquiring unit 320 that acquires the first image data indicating the first image which is an image to be printed, and the display controller 330 that causes the display 50 to display the second image which is a preview image of the first image, using the color material information and the first image data. Therefore, according to the image forming apparatus 1 of the present exemplary embodiment, an image to be formed by the image forming apparatus 1 using the acquired first image data is displayed on the display 50 using the color material information indicating the color materials filled in the containers actually mounted to the image forming apparatus 1.

In addition, the image forming apparatus 1 of the present exemplary embodiment determines whether the mounted portions 10 which the containers filled with the color materials are to be mounted to and which are determined based on a combination of the color materials indicated by the color material information are different from the respective mounted portions 10 to which the containers are actually mounted. When the determination result is “No”, the user is notified that the mounting position is not correct.

### <Modifications>

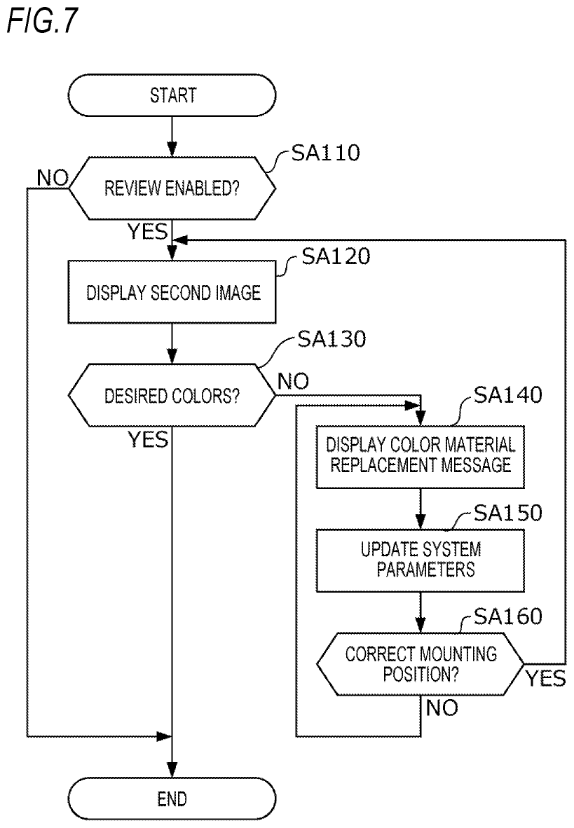

The exemplary embodiment has been described above. The contents of this exemplary embodiment may be modified as follows. The following modifications may be used in combination.

<1> In the above exemplary embodiment, the mounted portions 10-1 to 10-4 are capable of receiving plural colors. Alternatively, one to three of the mounted portions 10-1 to 10-4 may be capable of receiving plural colors. In a case where an image forming apparatus includes five mounted portions 10, the last mounted portion 10 (that is, the mounted portion 10 to which a container filled with a color material, which is transferred to the uppermost position, is mounted) may be fixed to a transparent color material such as a transparent toner, and the other four mounted portions 10 may be capable of receiving plural colors.
<2> In the preview displaying process of the exemplary embodiment, the process of step SA160 is performed when the determination result in step SA130 is “Yes”. However, as illustrated in FIG. 7, the process may be modified to execute the process of step SA160 following step SA150. In addition, in the preview displaying process illustrated in FIG. 7, the process of step SA140 also serves as the process of step SA170 and the process of step SA150 also serves as the process of step SA180. Therefore, steps SA170 and SA180 are omitted in FIG. 7.
<3> The color material information in the above exemplary embodiment is data indicating a combination of color materials actually mounted to the image forming apparatus 1 and indicating the transfer order in which the respective colors are transferred. Alternatively, the color material information may play only the role of indicating the combination of color materials actually mounted to the image forming apparatus 1, and the position information (information indicating which container filled with which color material is mounted to which mounted portion) indicating the transfer order in which the respective colors are transferred may be prepared separately from the color material information. In the case where the position information is used separately from the color material information in this manner, in order to reflect the transfer order in which the respective colors are transferred in the second image, the display controller 330 may execute a process of causing the display 50 to display the second image using the position information in addition to the color material information and the first image data.
<4> In the exemplary embodiment, the example in which the present disclosure is applied to a laser printer has been described. Alternatively, the present disclosure may be applied to an inkjet printer. In the case of the inkjet printer, color materials are inks of the respective colors of K, C, M and Y, and the containers filled with the color materials are ink tanks.
<5> In the exemplary embodiment, the specifying unit 310 and the acquiring unit 320 are software modules. Alternatively, the respective units may be hardware modules such as an ASIC. In addition, in the exemplary embodiment, the display controller 330 that controls the display 50 is separate from the display 50. However, the display controller 330 and the display 50 may be integrated with each other and used as a display that displays the second image using the color material information and the first image data. In addition, an information processing device implemented by a combination of the specifying unit 310, the acquiring unit 320 and the display that displays the second image using the color material information and the first image data may be manufactured and/or sold alone. In summary, an information processing device may be provided that includes a specifying unit in which an image forming apparatus includes one or more mounted portions to which containers filled with different types of color materials are mountable, the specifying unit that specifies color material information indicating a color material filled in a container actually mounted to the one or more mounted portions, an acquiring unit that acquires first image data indicating a first image, and a display that displays a second image using the color material information and the first image data.
<6> In the exemplary embodiment, the storage unit of the information processing device 30 stores, in advance, a program that causes the information processing device 30 to function as the specifying unit 310, the acquiring unit 320, and the display controller 330. Alternatively, a program that causes a computer that controls an image forming apparatus including a display and one or more mounted portions to which containers filled with different types of color materials are mountable, to function as the specifying unit 310, the acquiring unit 320, and the display controller 330 may be manufactured and/or sold alone. In addition, specific examples of a manner in which the program is distributed include (i) writing the program in a computer-readable recording medium such as a flash ROM and distributing the computer-readable recording medium and (ii) distributing the program by means of download via a communication line such as the Internet. Further, the program in the exemplary embodiment is an application program in a printer. Alternatively, the program may be a printer driver for a personal computer.

The foregoing description of the exemplary embodiments of the present disclosure has been provided for the purposes of illustration and description. It is not intended to be exhaustive or to limit the present disclosure to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a specifying unit, wherein an image forming apparatus includes one or more mounted portions to which containers filled with different types of color materials are mountable,
the specifying unit configured to specify color material information indicating a color material filled in a container actually mounted to the one or more mounted portions in the image forming apparatus;
an acquiring unit configured to acquire first image data indicating a first image; and
a display configured to display a second image using the color material information and the first image data.

2. The information processing device according to claim 1, wherein
when mounted portions which the respective containers filled with the color materials are to be mounted to and which are determined based on a combination of the color materials indicated by the color material information are different from the respective mounted portions to which the containers are actually mounted, the display displays a message indicating that the containers are not mounted to the mounted portions to which the containers are to be mounted.

3. The information processing device according to claim 1, wherein
the display displays the second image using position information indicating which container filled with which color material is mounted to which mounted portion, in addition to the color material information and the first image data.

4. The information processing device according to claim 2, wherein
the display displays the second image using position information indicating which container filled with which color material is mounted to which mounted portion, in addition to the color material information and the first image data.

5. An image forming apparatus comprising:
the information processing device according to claim 1;
the one or more mounted portions to which the containers filled with the different types of color materials are mountable;
a supply unit configured to supply the color material information indicating the color material filled in the container actually mounted to the one or more mounted portions, to the information processing device; and
an image forming unit configured to form the first image on a medium using the color material information and the first image data acquired by the information processing device.

6. An image forming apparatus comprising:
the information processing device according to claim 2;
the one or more mounted portions to which the containers filled with the different types of color materials are mountable;
a supply unit configured to supply the color material information indicating the color material filled in the container actually mounted to the one or more mounted portions, to the information processing device; and
an image forming unit configured to form the first image on a medium using the color material information and the first image data acquired by the information processing device.

7. An image forming apparatus comprising:
the information processing device according to claim 3;
the one or more mounted portions to which the containers filled with the different types of color materials are mountable;
a supply unit configured to supply the color material information indicating the color material filled in the container actually mounted to the one or more mounted portions, to the information processing device; and
an image forming unit configured to form the first image on a medium using the color material information and the first image data acquired by the information processing device.

8. An image forming apparatus comprising:
the information processing device according to claim 4;
the one or more mounted portions to which the containers filled with the different types of color materials are mountable;
a supply unit configured to supply the color material information indicating the color material filled in the container actually mounted to the one or more mounted portions, to the information processing device; and
an image forming unit configured to form the first image on a medium using the color material information and the first image data acquired by the information processing device.

9. A non-transitory computer readable medium storing a program causing a computer that controls an image forming apparatus including a display and one or more mounted portions to which containers filled with different types of color materials are mountable, to execute information processing, the information processing comprising:
specifying color material information indicating a color material filled in a container actually mounted to the one or more mounted portions;
acquiring first image data indicating a first image; and
displaying a second image on the display using the color material information and the first image data.

10. An information processing device comprising:
specifying means, wherein an image forming apparatus includes one or more mounted portions to which containers filled with different types of color materials are mountable,
the specifying means for specifying color material information indicating a color material filled in a container actually mounted to the one or more mounted portions in the image forming apparatus;
means for acquiring first image data indicating a first image; and
means for displaying a second image using the color material information and the first image data.
